(19) United States
(12) Patent Application Publication
(10) Pub. No.: US 2023/0211444 A1
(43) Pub. Date: Jul. 6, 2023

(54) SYSTEM FOR FIXING A TOOLING BIT TO A TOOL AND CORRESPONDING FIXING METHOD

(71) Applicant: ETABLISSEMENTS GEORGES RENAULT, SAINT HERBLAIN (FR)

(72) Inventors: Aurélien Robineau, (US); Eddie Lerat, VIGNEUX DE BRETAGNE (FR)

(21) Appl. No.: 18/069,426

(22) Filed: Dec. 21, 2022

(30) Foreign Application Priority Data
Dec. 22, 2021 (FR) 2114258

(51) Int. Cl. B23Q 3/157; B23Q 3/155

(52) U.S. Cl. CPC B23Q 3/15713; B23Q 3/1554; B23Q 2003/15537; B23Q 2003/15527

(57) ABSTRACT

A system for fixing a tooling bit to a tool having an axis of rotation for working the bit. The system includes: a bit box having a plurality of movable bit supports, each carrying a bit, each bit having a first working end and a second end; a bit holder having a first end securable to one end of the tool and a second end securable to the second end of each of the bits; and a reversible element for securing the bit to the bit holder. The bit has a locked state wherein the bit is engaged on the bit holder and is distanced from the bit support, and a released state wherein the bit is distanced from the bit holder and rests on the bit support.

### 1. FIELD OF THE INVENTION

The field of the invention is that of the techniques implemented to ensure the positioning of a tool bit, such as for example a screw driving bit or the like, at the end of a tool.

More specifically, the invention relates to a device intended to be implemented to fix a tooling bit to a tool or to collect a tooling bit after it has been detached from the tool.

The invention finds in particular, but not exclusively, its application in the field of robots, cobots (or collaborative robots), or X-Y-Z tables.

### 2. PRIOR ART

Tools with interchangeable bits are commonly used in various fields of activity to work towards the completion of various tasks. For example, use is made of screwdrivers at the end of which it is possible to attach screw driving bits of different sizes selected according to the type and size of the element to be moved in order to tighten or loosen it.

A person skilled in the art seeks to improve the existing technique so as to reduce the manipulations to be carried out by a user.

In particular, techniques are known wherein automatic bit boxes are implemented.

For example, documents US 2018 141 172 and US 2009 139 375 are known about solutions for changing tool bits implementing a pneumatic actuator which is arranged on the tool side or on the bit box side. This pneumatic actuator is implemented in such a way as to engage the tool bit on the tool or to disengage it.

However, these solutions are complex to be implemented, and are also expensive both to be implemented and for regular maintenance.

Indeed, it is relatively difficult to integrate such solutions on production lines due to the presence of actuators which require pneumatic or even electric control, which implies a possible supply of energy and therefore a significant modification of the lines, which is not satisfactory.

Furthermore, these solutions are likely to break down and therefore require significant maintenance due to the actuators, which also generates additional cost as well as loss of time, which is not satisfactory.

Also known are solutions implementing means for reversibly securing a bit holder to a bit provided on a bit support, which can assume a locked state and an unlocked state and which are configured to switch from one to the other of their states by a relative movement of the bit support with respect to the bit holder along a single axis.

However, such a solution requires the implementation of many parts which represents an additional cost in terms of implementation which is not satisfactory.

Furthermore, such a number of parts also generates a maintenance surplus which also generates an additional cost as well as loss of time which is not satisfactory.

There is therefore a need to improve such systems, both in terms of cost price and reliability and service life.

### 3. DESCRIPTION OF THE INVENTION

At least one exemplary embodiment of the invention meets this need by proposing a system for attaching a tooling bit to a tool, said system comprising:
a bit box comprising a plurality of bit supports, said bit supports being movable and each carrying a bit, each bit having a first working end and a second end;
a bit holder having a first end able to be secured to one end of said tool and a second end configured to be secured to said second end of each of said bits;
reversible means for securing said bit to said bit holder, said bit being able to assume at least two states with respect to said bit holder:
a locked state wherein said bit is engaged on said bit holder and is at a distance from said bit support, and
a released state wherein said bit is at a distance from said bit holder and rests on said bit support,

switching from said released state to said locked state being made by the combination of a first movement along the axis Z of rotation of the tool of said bit holder towards said bit support so that said bit holder faces said bit support, and a second movement of said bit holder carrying with it said bit support, so that the bit is engaged and locked on said bit holder.

Therefore, an exemplary embodiment of the invention allows to change the bit by implementing only simple usual movements, which gives the advantage of being able to be used with any robot or cobot, without implementing an additional actuator.

This further allows, therefore, to implement a solution having a limited size and with simple means, for example conventional bits which can be purchased commercially.

According to one aspect of at least one embodiment of the invention, said bit supports are mounted to move in translation in a plane P perpendicular to the axis Z of rotation of the tool, switching from said released state to said locked state being made by the combination of a translation of said bit holder along the axis Z, and a translation in the plane P, carrying with it said bit support, so that said bit holder faces said bit support and that the bit 3 is engaged and locked on said bit holder 4.

According to one aspect of at least one embodiment of the invention, said bit holder is mounted to move in translation along an axis X perpendicular to the axis Z of rotation of the tool, switching from said released state to said locked state being made by the combination of a translation of said bit holder along the axis Z, and a translation along the axis X, carrying with it said bit support, so that said bit holder faces said bit support and that the bit is engaged and locked on said bit holder.

According to one aspect of at least one embodiment of the invention, said reversible securing means comprise:
a locking element arranged in said bit holder and movable between at least one released position wherein it does not act on said bit, and a locking position wherein it is housed in locking means of said bit, said locking element and said locking means of said bit having a complementary shape;
a movable expander element between at least one deployed position wherein it holds the locking element in the locking position in said locking means of said bit, and a folded position wherein it does not act on said locking element, and
an activation element secured to the expander element and arranged on the periphery of said bit holder.

According to one aspect of at least one embodiment of the invention, the locking element comprises balls provided in the bit holder, on the periphery of the expander element.

According to one aspect of at least one embodiment of the invention, said activation element is a ring arranged on the periphery of said bit holder and secured to said locking element.

According to one aspect of at least one embodiment of the invention, said expander element comprises a rod movable between at least one deployed position wherein it holds the locking element in the locking position in said locking means of said bit, and a folded position wherein it does not act on said locking element.

According to one aspect of at least one embodiment of the invention, said bit box includes an upper bearing surface on which are formed openings each arranged facing each of said bits, each of said openings having:
a first portion having a diameter less than a diameter of said activation element, and having a diameter greater than a diameter of said bit;
a second portion formed in the continuity of said first portion and having a diameter greater than a diameter of said activation element.

According to one aspect of at least one embodiment of the invention, the bit box comprises between two and eight bit supports, preferably four bit supports.

According to one aspect of at least one embodiment of the invention, each of the bit supports further comprises at least one sensor belonging to the group comprising:
a sensor for the presence of a bit in contact with the associated bit support;
a sensor for detecting the position of a bit relative to a bit holder;
a sensor for the presence of the bit support vertically to the first portion of the opening, and
a sensor for the presence of a bit vertically above the first portion of the opening.

An exemplary embodiment of the invention also relates to a method for fixing a tooling bit to a tool implemented by a system for fixing a tooling bit to a tool implementing the following successive steps:
a step of predetermining a bit to be fixed on the bit holder;
a step of positioning said bit holder in contact with said upper bearing surface, facing the first portion of the opening corresponding to the predetermined bit, so as to be vertical to said bit;
a first step of translating said bit holder along said axis so that said second end of said bit holder is secured to said second end of the predetermined bit, said activation element remaining in contact with said upper bearing surface;
simultaneously, a step of switching the locking element to the released position wherein it is housed in the locking means of the predetermined bit;
a second step of moving said bit holder, said bit holder driving in its movement said bit support and said predetermined bit until said bit holder and said bit are positioned opposite said second portion of the opening;
a step of switching the expander element from said folded position to said deployed position wherein it holds the locking element in the locking position in said locking means of said bit, said activation element being translated simultaneously along the axis Z so as to be opposite said predetermined bit,
a step of extracting the bit by translating said bit holder along said axis Z until said bit holder is at a distance from said bit box.

According to at least one aspect, the locking element switches from any position to the released position wherein it is housed in locking means of the predetermined bit.

According to at least one aspect, the locking element switches from the retracted position to the released position wherein it is housed in locking means of the predetermined bit.

According to one aspect of at least one embodiment of the invention, the method further comprises the following successive steps, to remove the bit from said tool:
a step of positioning said bit holder vertically to said second portion of the opening associated with the bit, so that said activation element is at said upper bearing surface;
a third step of moving said bit holder until said bit holder is positioned opposite said first portion of the opening and said bit support;
a fourth step of translating said bit holder along said axis Z so that said predetermined bit is placed on the associated bit support;
a step of depositing said bit on said associated bit support;
a fifth step of translating said bit holder along said axis Z until said bit holder is at a distance from said bit box.

### 4. DESCRIPTION OF FIGURES

Other features and advantages of the invention will appear upon reading the following description of particular embodiments, given by way of simple illustrative and non-limiting example, and the appended drawings, among which:

FIG. 1 illustrates in perspective from the front a bit box provided with four bit supports according to one embodiment of the invention;

FIG. 2a also illustrates in perspective from the front a bit box provided with four bit supports according to the embodiment of FIG. 1;

FIG. 2b illustrates in perspective from behind a bit box provided with four bit supports according to the embodiment of FIG. 1;

FIG. 3 illustrates in side section a tool and a box according to one embodiment of the invention;

FIG. 4a illustrates in side section a portion of the method for fixing a tooling bit to a tool according to one embodiment of the invention;

FIG. 4b illustrates in side section a following portion of the method for fixing a tooling bit to a tool according to the embodiment of FIG. 4a;

FIG. 4c illustrates in side section a following portion of the method for fixing a tooling bit to a tool according to the embodiment of FIG. 4b;

FIG. 5a illustrates in side section a following portion of the method for fixing a tooling bit to a tool according to the embodiment of FIG. 4c;

FIG. 5b illustrates in side section a following portion of the method for fixing a tooling bit to a tool according to the embodiment of FIG. 5a;

FIG. 5c illustrates in side section a following portion of the method for fixing a tooling bit to a tool according to the embodiment of FIG. 5b;

FIG. 6a illustrates in side section a following portion of the method for fixing a tooling bit to a tool, namely the removal of the bit, according to one embodiment of the invention;

FIG. 6b illustrates in side section a following portion of the method for fixing a tooling bit to a tool, namely the removal of the bit, according to the embodiment of FIG. 6a;

FIG. 6c illustrates in side section a following portion of the method for fixing a tooling bit to a tool, namely the removal of the bit, according to the embodiment of FIG. 6b;

FIG. 7a illustrates in side section a following portion of the method for fixing a tooling bit to a tool, namely the removal of the bit, according to the embodiment of FIG. 6c, and

FIG. 7b illustrates in side section a following portion of the method for fixing a tooling bit to a tool, namely the removal of the bit, according to the embodiment of FIG. 7a.

### 5. DETAILED DESCRIPTION OF AN EMBODIMENT OF THE INVENTION

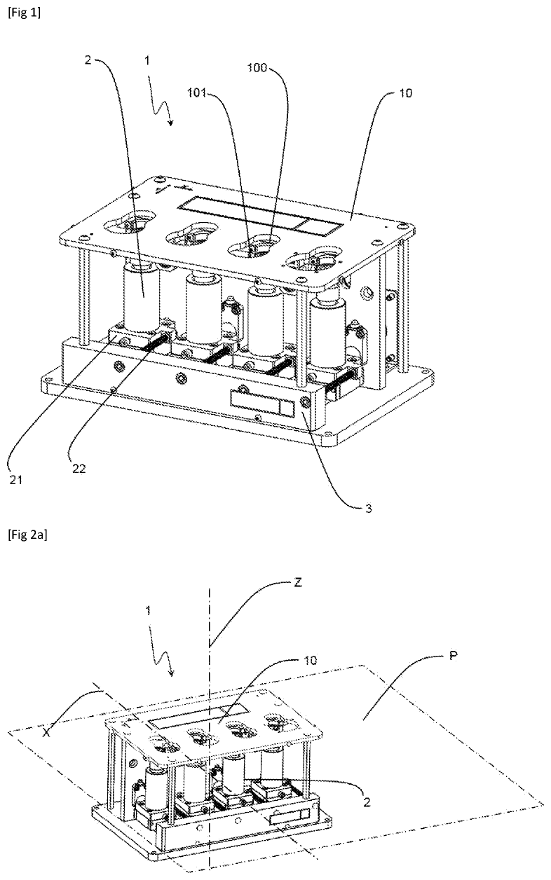

An embodiment of the invention will now be presented, in relation to FIGS. 1 to 7b, as a system and method.

The invention relates to a system for fixing a tooling bit to a tool 9.

The tool can for example be a screwdriver at the end of which it is desired to fix a screw driving bit which can be cruciform or flat, or have any other shape (in the example presented, it is a female hexagonal bit). This screw driving bit can be of different sizes selected according to the type and size of the element to be moved to tighten or loosen this element.

The system comprises a bit box 1, a bit holder 4, and means for reversibly securing the bit to the bit holder.

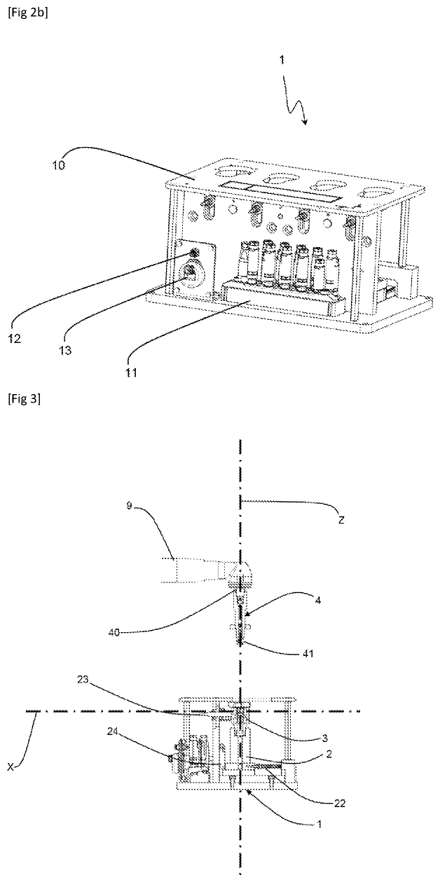

The system therefore comprises a bit box 1, more particularly illustrated in FIGS. 1 to 2b. In this embodiment, the box is parallelepipedic in shape and comprises four bit supports 2.

However, according to other non-limiting embodiments, the bit box could comprise for example between one and sixteen bit supports, or between two and eight bit supports, or between three and six bit supports.

As illustrated in these figures, this bit box 1 includes an upper bearing surface 10 on which are formed openings each arranged facing each of the bit supports 2.

Each of these openings has a first portion 100 and a second portion 101, arranged in the continuity of the first portion 100, and having a diameter greater than a diameter of the first portion.

These openings here have the shape of a lock. However, other embodiments could also be provided wherein the shape of these openings would be different. Provision can also be made of embodiments wherein the openings do not all have the same shape.

The bit box 1 of the embodiment presented further comprises power supply means 11, in particular for power supplying sensors, as well as connection means, which can for example comprise an Ethernet connector 12 or an M8 connector 13.

The bit supports 2 are mounted to move in translation along an axis X and are configured to each carry a bit 3.

More particularly, each bit 3 has a first working end and a second end. The bit supports 2 are configured so that they can accommodate the first working end. In this way the second end of each of the bits is placed facing each of the openings of the upper bearing surface 10.

So as to be movable in translation, each of the bit supports 2 is mounted on a carriage 21 which is guided by means of a rod 22 positioned along the axis X.

According to the illustrated embodiment, each of the bit supports 2 further comprises two sensors 23, 24 belonging to the group comprising:
a sensor for the presence of a bit in contact with the associated bit support 2;
a sensor for detecting the position of a bit 3 relative to a bit holder;
a sensor for the presence of the bit support vertically to the first portion of the opening, and
a sensor for the presence of the bit vertically above the first portion of the opening.

However, according to variants of the illustrated embodiment, each of the bit supports could comprise a single sensor, or more than two sensors belonging to this group of sensors.

The system also comprises a bit holder 4 which has a first end 40 capable of being secured to one end of the tool 9 as well as a second end 41 configured to be secured to the second end of each of the bits 3.

According to an exemplary embodiment of the invention, the bit 3 can assume at least two states with respect to the bit holder 4:
a locked state wherein the bit 3 is engaged on the bit holder 4 and is at a distance from the bit support 2, and
a released state wherein the bit 3 is at a distance from the bit holder 4 and engaged on the bit support 2.

This switching from the released state to the locked state is done, in this embodiment, by the combination of a translation along an axis Z substantially perpendicular to the axis X of the bit holder 4, and a translation along the axis X of the bit support 2 and the bit holder 4, so that the bit holder 4 faces the bit support 2 and the bit 3 is engaged on the bit holder 4.

In other words, switching from the locked state to the released state of the bit 3 in the bit holder 4 is done by a combination of a translation along an axis Z substantially perpendicular to the axis X of the bit holder 4, so that the bit holder is vertical to the bit 3, and the second end 41 of the bit holder is secured to the second end of the selected (or predetermined) bit 3, then a translation along the axis X of the bit support 2 and the bit holder 4, so that the bit 3 is locked on the bit holder 4 by means of the fastening means.

It should be noted that this axis Z corresponds, in a preferred embodiment, to the axis of rotation of the tool and of the bit holder.

However, according to other embodiments not shown, switching from said released state to said locked state could be done by the combination of a first movement of said bit holder towards said bit support so that said bit holder faces said bit support, and a second movement of said bit holder carrying with it said bit support, so that the bit is engaged and locked on said bit holder.

In order to secure a bit 3 to the bit holder 4, the system therefore comprises reversible means for securing the bit 3 to the bit holder 4.

In the embodiment illustrated here, the reversible securing means comprise:
a locking element 50 arranged in the bit holder 4;
an expander element 51 also provided in the bit holder 4, and
an activation element 52 secured to the expander element 51 and arranged on the periphery of the bit holder 4.

The locking element 50 is mounted to move between at least one released position wherein it does not act on the bit 3, and a locking position wherein it is housed in locking means 30 of the bit 3. It should be noted that the locking element 50 and the locking means 30 of the bit 3 have a complementary shape, so that the locking and the holding in position are optimal.

In this embodiment, the locking element 50 comprises balls arranged in the bit holder, on the periphery of the expander element 51. Therefore, in this embodiment, the locking means 30 of the bit are housings corresponding to the size of each of the balls so that each of them is housed in a housing provided in the bit 3.

It should be noted that in other embodiments, any locking means known to the person skilled in the art and which would be adaptable so that the locking element can be housed in the locking means is possible.

As for the expander element 51, it is mounted to move between at least one deployed position wherein it holds the locking element 50 in the locking position in the locking means 30 of the bit 3, and a folded position wherein it does not act on the locking element 50.

In this embodiment, the expander element 51 comprises a movable rod between at least one deployed position wherein it holds the locking element 50, which here comprises balls, in the locking position in the locking means 30 of the bit 3, which in this embodiment are housings for the balls, and a folded position wherein the rod does not act on the locking element 50, because it is retracted inside the bit holder 4.

However, in other embodiments, any expander element known to the person skilled in the art and which would be adaptable so as to act on the locking element to hold it in the locking means is possible.

The deployed position here corresponds to a position wherein the rod is partly housed in the bit, and more particularly in a channel of the bit placed opposite the rod. The folded position corresponds to a position wherein the rod is entirely located in the bit holder 4.

For its part, the activation element 52 is, in this embodiment, a ring arranged on the periphery of the bit holder 4 and secured to the locking element 50.

Logically, the activation element therefore has a diameter greater than the diameter of the bit holder 4 because it is provided on the periphery.

In addition, the securing means are sized so that:
the first portion 100 has a diameter less than a diameter of the activation element 52, and has a diameter greater than a diameter of the bit 3;
the second portion 101, arranged in the continuity of the first portion 100, has a diameter greater than a diameter of the activation element 52.

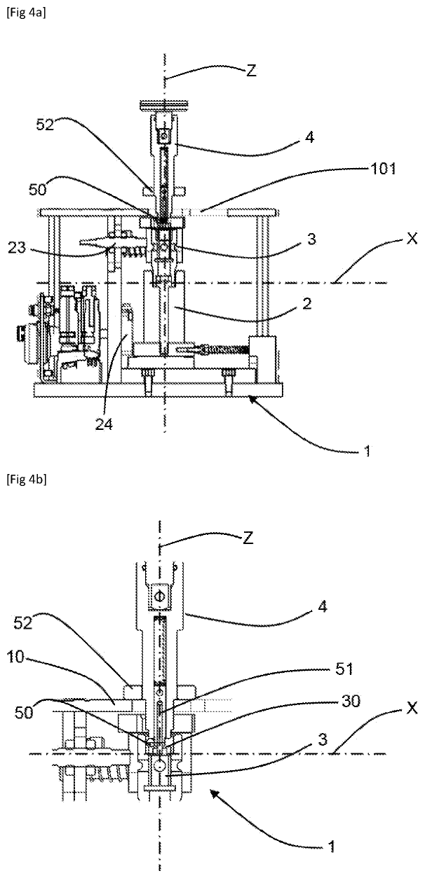

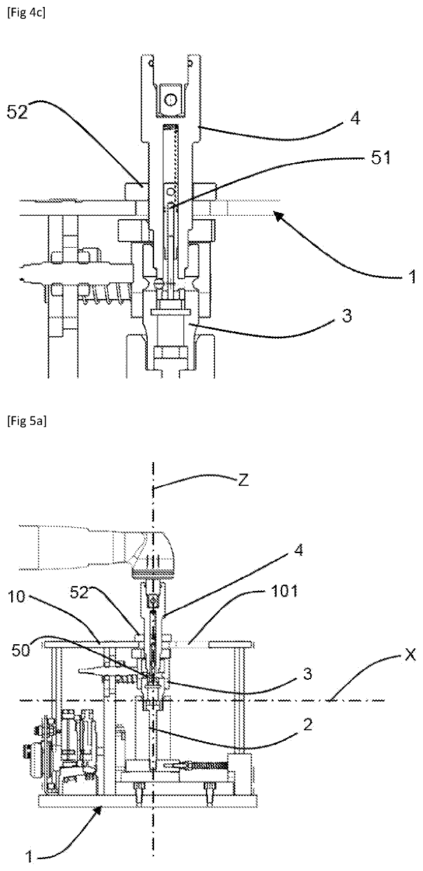

An embodiment of a method for fixing a tooling bit to a tool implemented by a system for fixing a tooling bit to a tool according to the embodiment presented above, will now be presented in relation to FIGS. 4a to 7b.

As illustrated, the method for fixing a tooling bit to a tool implements the following successive steps:
a step of predetermining a bit 3 to be fixed on the bit holder 4;
a step of positioning the bit holder 4 in contact with the upper bearing surface 10, facing the first portion 100 of the opening corresponding to the predetermined bit, so as to be vertical to the bit 3;
a first step of translating the bit holder along the axis Z so that the second end 41 of the bit holder 4 is secured to the second end of the predetermined bit 3;
a step of switching the locking element 50 from the retracted position to said released position wherein it is housed in the locking means 30 of the predetermined bit 3;
a second step of translating the bit holder 4 along the axis of translation X of the bit support 2, the bit holder driving in its translation the bit support 2 and the predetermined bit 3 until the bit holder 4 and the bit 3 are positioned opposite the second portion 101 of the opening;
simultaneously, a step of switching the expander element 51 from the folded position to the deployed position wherein it holds the locking element 50 in the locking position in the locking means 30 of the bit 3, said activation element 52 being translated simultaneously along the axis Z so as to be opposite said predetermined bit 3,
a step of extracting the bit 3 by translation of the bit holder 4 along the axis Z until the bit holder 4 is at a distance from the bit box 1.

However, according to other embodiments not shown, the method could comprise, instead of the first and second translation steps, steps of first and second movement of said bit holder, the first movement of said bit holder being towards said bit support so that said bit holder faces said bit support, and the second movement of said bit holder carrying with it said bit support, so that the bit is engaged and locked on said bit holder.

It should be noted that, in these embodiments not illustrated here, the movement could for example be a curvilinear movement, formed of several rectilinear movements, or even helical movement.

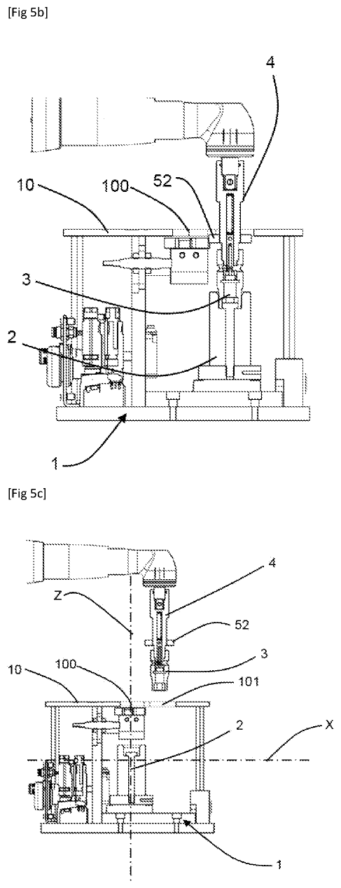

The various steps of the method presented above are detailed below, in support of FIGS. 4a to 5c.

FIG. 4a illustrates the step of positioning the bit holder 4 in contact with the upper bearing surface 10, facing the first portion 100 of the opening corresponding to the predetermined bit, so as to be vertical to the predetermined bit 3.

FIG. 4b illustrates the first step of translating the bit holder along the axis Z so that the second end 41 of the bit holder 4 is secured to the second end of the predetermined bit 3.

During this first translation step, and as illustrated in this FIG. 4b, the activation element 52 remains in contact with the upper bearing surface 10.

FIG. 4c illustrates the step of switching the locking element 50 from the retracted position to said released position wherein it is housed in the locking means 30 of the predetermined bit 3.

FIGS. 5a and 5b illustrate the second step of translating the bit holder 4 along the axis of translation X of the bit support 2, and simultaneously the step of switching the expander element 51 from the folded position to the deployed position.

During the second step of translating the bit holder 4 along the axis of translation X of the bit support 2, the bit holder driving in its translation the bit support 2 and the predetermined bit 3 until the bit holder 4 and the bit 3 are positioned opposite the second portion 101 of the opening.

Simultaneously, this causes the expander element 51 to switch from the folded position to the deployed position wherein it holds the locking element 50 in the locking position in the locking means 30 of the bit 3.

This step of switching the expander element 51 from the folded position to the deployed position is possible because, simultaneously, the activation element 52 is translated along the axis Z so as to be opposite the predetermined bit 3.

In other words, according to the method presented in this embodiment, passing through the second opening 102, this activation element 52 allows to switch the expander element 51 from the folded position to the deployed position.

Finally, FIG. 5c illustrates the step of extracting the bit 3 by translation of the bit holder 4 along the axis Z until the bit holder 4 is at a distance from the bit box 1.

The tool is then functional to carry out the task for which the bit retrieved in box 1 had been determined.

Once the task is completed, it is necessary to remove the bit from the tool, for example, to store the tool or change the bit.

For this purpose, the method further comprises the following successive steps, to remove the bit 3 from the tool 9:
a step of positioning the bit holder 4 vertically to the second portion of the opening 101 associated with the bit 3, so that the activation element 52 is at the upper bearing surface 10;
a third step of translating the bit holder 4 along the axis of translation X of the bit support 2, until the bit holder 4 is positioned opposite the first portion of the opening 100 and the bit support 2;
a fourth step of translating the bit holder along the axis Z so that the bit 3 held on the tool is placed on the associated bit support 2;
a step of depositing the bit 3 on the associated bit support 2;
a fifth step of translating the bit holder 4 along the axis Z until the bit holder 4 is at a distance from the bit box 1.

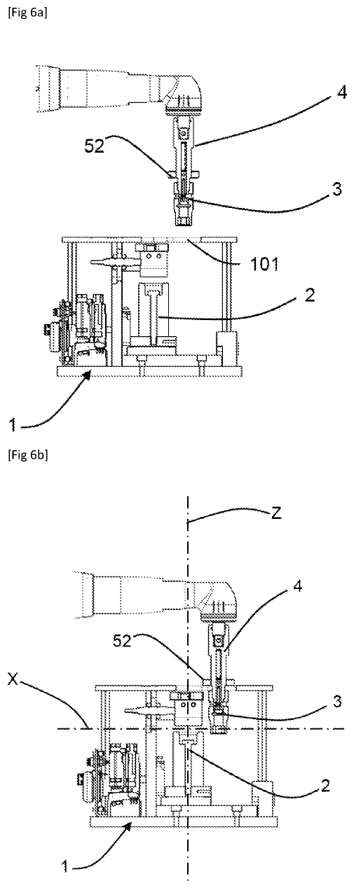

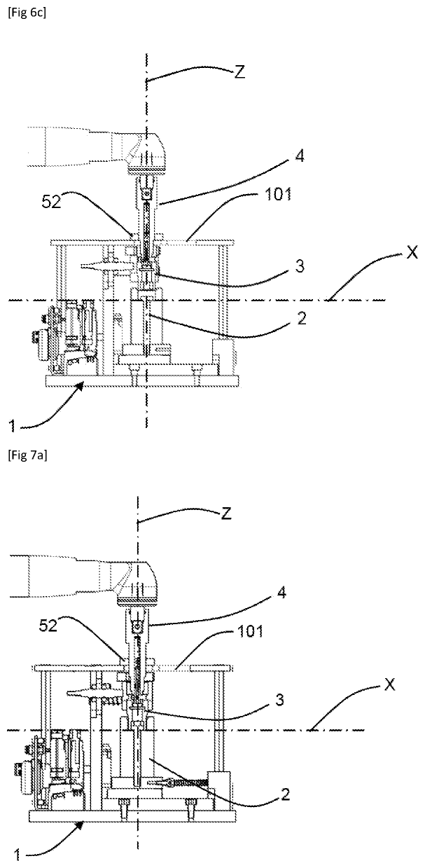

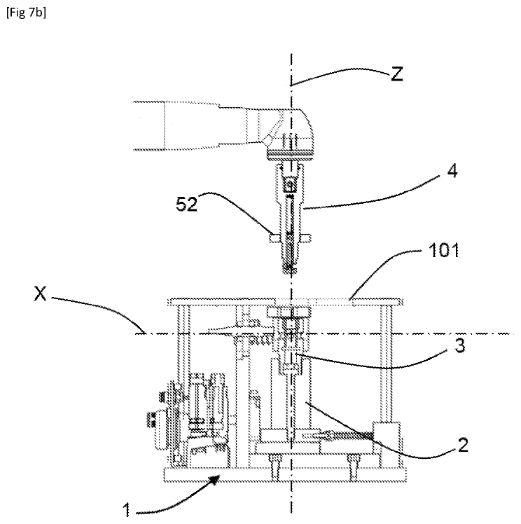

The various steps of the method according to an exemplary embodiment of the invention are detailed below, to remove the bit 3 from the tool once the task has been completed, in support of FIGS. 6a to 7b.

FIGS. 6a and 6b illustrate the step of positioning the bit holder 4 vertically to the second portion of the opening 101 associated with the predetermined bit 3, so that the activation element 52 is at the upper bearing surface 10, then the third step of translating the bit holder 4 along the axis of translation X of the bit support 2 until the bit holder 4 is positioned facing the first portion of the opening 100 and the bit support 2.

FIG. 6c illustrates the fourth step of translating the bit holder 4 along the axis Z so that the predetermined bit 3 is placed on the associated bit support 2.

FIG. 7a in turn illustrates the step of depositing the bit 3 on the associated bit support 2.

For this purpose, the bit support may include means for retaining the bit. For example, the bit support may include a bit retaining fork provided with a tension spring, configured to retain the bit on the bit support when the bit holder is raised.

Finally, FIG. 7b illustrates the fifth step of translating the bit holder 4 along the axis Z until the bit holder 4 is at a distance from the bit box 1.

1. A fixing system for fixing a tooling bit to a tool having an axis of rotation (Z) for working the bit, wherein said system comprises:
a bit box comprising a plurality of bit supports, said bit supports being movable and each carrying a bit, each bit having a first working end and a second end;
a bit holder having a first end able to be secured to one end of said tool and a second end configured to be secured to said second end of each of said bits;
a reversible securing element to secure said bit to said bit holder, said bit being able to assume at least two states with respect to said bit holder, comprising:
a locked state wherein said bit is engaged on said bit holder and is at a distance from said bit support, and
a released state wherein said bit is at a distance from said bit holder and rests on said bit support,
wherein the bit is switchable from said released state to said locked state by a combination of a first movement along the axis (Z) of rotation of the tool of said bit holder towards said bit support so that said bit holder faces said bit support, and a second movement of said bit holder carrying with it said bit support, so that the bit is engaged and locked on said bit holder.

2. The fixing system according to claim 1, wherein said bit supports are mounted to move in translation in a plane (P) perpendicular to the axis (Z) of rotation of the tool, switching from said released state to said locked state being made by the combination of a translation of said bit holder along the axis (Z), and a translation in the plane P, carrying with it said bit support, so that said bit holder faces said bit support and the bit is engaged and locked on said bit holder.

3. The fixing system according to claim 1, wherein said bit holder is mounted to move in translation along an axis (X) perpendicular to the axis (Z), switching from said released state to said locked state being made by the combination of a translation of said bit holder along the axis (Z), and a translation along the axis (X), carrying with it said bit support, so that said bit holder faces said bit support and that the bit is engaged and locked on said bit holder.

4. The fixing system according to claim 1, wherein said reversible securing element comprises:
a locking element arranged in said bit holder and movable between at least one released position wherein it does not act on said bit, and a locking position wherein it is housed in locking means of said bit, said locking element and said locking means of said bit having a complementary shape;
an expander element movable between at least one deployed position wherein it holds the locking element in the locking position in said locking means of said bit, and a folded position wherein it does not act on said locking element, and
an activation element secured to the expander element and arranged on a periphery of said bit holder.

5. The fixing system according to claim 4, wherein said locking element comprises balls provided in the bit holder, on the periphery of said expander element.

6. The fixing system according to claim 4, wherein said activation element comprises a ring arranged on the periphery of said bit holder and secured to said locking element.

7. The fixing system according to claim 4, wherein said expander element comprises a rod movable between at least one deployed position wherein the expander element holds the locking element in the locking position in said locking means of said bit, and a folded position wherein the expander element does not act on said locking element.

8. The fixing system according to claim 4, wherein the said bit box includes an upper bearing surface on which are formed openings each arranged facing each of said bits, each of said openings having:
a first portion having a diameter less than a diameter of said activation element, and having a diameter greater than a diameter of said bit;
a second portion formed in the continuity of said first portion and having a diameter greater than a diameter of said activation element.

9. The fixing system according to claim 1, wherein the bit box comprises from two to eight bit supports.

10. The fixing system according to claim 1, wherein each of the bit supports further comprises at least one sensor belonging to the group consisting of:
a sensor for presence of a bit in contact with the associated bit support;
a sensor for detecting position of a bit relative to a bit holder;
a sensor for presence of the bit support vertically to the first portion of the opening, and
a sensor for presence of the bit vertically above the first portion of the opening.

11. A method for fixing a tooling bit to a tool implemented by a system for fixing a tooling bit to a tool having an axis of rotation (Z) for working the bit, wherein said system comprises:
a bit box comprising a plurality of bit supports, said bit supports being movable and each carrying a bit, each bit having a first working end and a second end;
a bit holder having a first end able to be secured to one end of said tool and a second end configured to be secured to said second end of each of said bits;
a reversible securing element to secure said bit to said bit holder, said bit being able to assume at least two states with respect to said bit holder, comprising:
a locked state wherein said bit is engaged on said bit holder and is at a distance from said bit support, and
a released state wherein said bit is at a distance from said bit holder and rests on said bit support,
wherein the bit is switchable from said released state to said locked state by a combination of a first movement along the axis (Z) of rotation of the tool of said bit holder towards said bit support so that said bit holder faces said bit support, and a second movement of said bit holder carrying with it said bit support, so that the bit is engaged and locked on said bit holder,
wherein said reversible securing element comprises:
a locking element arranged in said bit holder and movable between at least one released position wherein it does not act on said bit, and a locking position wherein it is housed in locking means of said bit, said locking element and said locking means of said bit having a complementary shape;
an expander element movable between at least one deployed position wherein it holds the locking element in the locking position in said locking means of said bit, and a folded position wherein it does not act on said locking element, and
an activation element secured to the expander element and arranged on a periphery of said bit holder,
wherein the said bit box includes an upper bearing surface on which are formed openings each arranged facing each of said bits, each of said openings having:
a first portion having a diameter less than a diameter of said activation element, and having a diameter greater than a diameter of said bit;
a second portion formed in the continuity of said first portion and having a diameter greater than a diameter of said activation element, and
wherein the method comprises the following successive steps:
a step of predetermining a bit to be fixed on the bit holder;
a step of positioning said bit holder in contact with said upper bearing surface, facing the first portion of the opening corresponding to the predetermined bit, so as to be vertical to said bit;
a first step of translating said bit holder along said axis (Z) so that said second end of said bit holder is secured to said second end of the predetermined bit, said activation element remaining in contact with said upper bearing surface;
simultaneously, a step of switching the locking element to said released position wherein it is housed in the locking means of said predetermined bit;
a second step of moving said bit holder, said bit holder driving in its movement said bit support and said predetermined bit until said bit holder and said bit are positioned opposite said second portion of the opening;
a step of switching the expander element from said folded position to said deployed position wherein it holds the locking element in the locking position in said locking means of said bit said activation element being translated simultaneously along the axis (Z) so as to be opposite said predetermined bit,
a step of extracting the bit by translating said bit holder along said axis (Z) until said bit holder is at a distance from said bit box.

12. The method for fixing a tooling bit to said tool according to claim 11, wherein the method further comprises the following successive steps, to remove the bit from said tool:
a step of positioning said bit holder vertically to said second portion of the opening associated with the bit, so that said activation element is at said upper bearing surface;
a third step of moving said bit holder until said bit holder is positioned opposite said first portion of the opening and said bit support;
a fourth step of translating said bit holder along said axis (Z) so that said predetermined bit is placed on the associated bit support;
a step of depositing said bit on said associated bit support;
a fifth step of translating said bit holder along said axis (Z) until said bit holder is at a distance from said bit box.
